(19) United States
(12) Patent Application Publication
(10) Pub. No.: US 2022/0334010 A1
(43) Pub. Date: Oct. 20, 2022

(54) STRUCTURE AS A SENSOR

(71) Applicant: DIVERGENT TECHNOLOGIES, INC., Los Angeles, CA (US)

(72) Inventors: LUKAS PHILIP CZINGER, Santa Monica, CA (US); Matthew Cooper Keller, Marina Del Rey, CA (US); Bahram Issari, Los Angeles, CA (US)

(21) Appl. No.: 17/723,253

(22) Filed: Apr. 18, 2022

Related U.S. Application Data
(60) Provisional application No. 63/177,285, filed on Apr. 20, 2021.

(51) Int. Cl. G01L 1/22; B33Y 40/00; B33Y 80/00

(52) U.S. Cl. CPC G01L 1/2262; B33Y 40/00; B33Y 80/00; B33Y 10/00

(57) ABSTRACT

Methods and apparatuses for using a structure as a sensor are disclosed. An apparatus in accordance with an aspect of the present disclosure comprises an additively-manufactured component comprising a channel, a sensor including an connection point, wherein the sensor is arranged in the channel, and an adhesive arranged in the channel, the adhesive coupling the additively-manufactured component to the sensor, such that the connection point is accessible external to the adhesive, the sensor being configured to provide a signal at the connection point, wherein the signal provides information of an applied force on the additively-manufactured component.

### CROSS-REFERENCE TO RELATED APPLICATIONS

The present disclosure claims the benefit under 35 U.S.C. 119 of U.S. Provisional Patent Application No. 63/177,285, filed Apr. 20, 2021 and entitled “STRUCTURE AS A SENSOR”, which application is incorporated by reference herein in its entirety.

### BACKGROUND

### Field

The present disclosure relates generally to automotive structures, and more specifically to structures as sensors.

### Technical Field

The present disclosure relates generally to structures, and more specifically to measuring characteristics and performance of structures.

### DESCRIPTION OF THE RELATED TECHNOLOGY

Additive manufacturing (AM) techniques are capable of printing complex components using a wide variety of materials. A 3-D object is fabricated based on a computer-aided design (CAD) model. The AM process can manufacture a solid three-dimensional object directly from the CAD model without additional tooling.

One example of an AM process is powder bed fusion (PBF), which uses a laser, electron beam, or other source of energy to sinter or melt metallic powder deposited in a powder bed on a build plate, thereby consolidating powder particles together in targeted areas to produce a 3-D structure, often referred to as a build piece, having the desired geometry based on a stored geometrical model. Different materials or combinations of materials, such as metals, plastics, and ceramics, may be used in PBF to create the 3-D object. Other AM techniques, including those discussed further below, are also available or under current development, and each may be applicable to the present disclosure.

Another example of an AM process is Binder Jet (BJ) process that uses a powder bed (similar to PBF) in which metallic powder is spread in layers and bonded by using an organic binder. The resulting part is a “green” part, which requires burning off the binder and sintering to consolidate the layers into full density. The metallic powder material can have the same chemical composition and similar physical characteristics as PBF powders.

Another example of an AM process is Directed Energy Deposition (DED). DED is an AM technology that uses a laser, electron beam, plasma, or other method of energy supply, such as those in Tungsten Inert Gas (TIG), or Metal Inert Gas (MIG) welding to melt the metallic powder, wire, or rod, thereby transforming it into a solid metal object. Unlike many AM technologies, DED is not based on a powder bed. Instead, DED uses a feed nozzle to propel the powder or mechanical feed system to deliver wire or rod into the laser beam, electron beam, plasma beam, or other energy stream. The powdered metal or the wire or rod are then fused by the respective energy beam. While supports or a freeform substrate may in some cases be used to maintain the structure being built, almost all the raw material (powder, wire, or rod) in DED is transformed into solid metal, and consequently, little waste powder is left to recycle. Using a layer by layer strategy, the print head, comprised of the energy beam or stream and the raw material feed system, can scan the substrate to deposit successive layers directly from a CAD model.

PBF, BJ, DED, and other AM processes may use various raw materials such as metallic powders, wires, or rods, often referred to as feedstock. The raw material may be made from various metallic materials. Metallic materials may include, for example, aluminum, or alloys of aluminum. It may be advantageous to use alloys of aluminum that have properties that improve functionality within AM processes. For example, particle shape, powder size, packing density, melting point, flowability, stiffness, porosity, surface texture, density electrostatic charge, as well as other physical and chemical properties may impact how well an aluminum alloy performs as a material for AM. Similarly, raw materials for AM processes can be in the form of wire or rod whose chemical composition and physical characteristics may impact the performance of the material. Some alloys may impact one or more of these or other traits that affect the performance of the alloy for AM.

One or more aspects of the present disclosure may be described in the context of the related technology. None of the aspects described herein are to be construed as an admission of prior art, unless explicitly stated herein.

### SUMMARY

Several aspects of one or more structures, as well as methods of making and/or using the same, are described herein. For example, one or more structures may include sensors for measuring the performance of the structure. The one or more sensors may be built as part of the structure, or the structure may be designed to have the sensor added after the structure is manufactured.

An apparatus in accordance with an aspect of the present disclosure may comprise an additively-manufactured component comprising a channel, a sensor including an connection point, wherein the sensor is arranged in the channel, and an adhesive arranged in the channel, the adhesive coupling the additively-manufactured component to the sensor, such that the connection point is accessible external to the adhesive, the sensor being configured to provide a signal at the connection point, wherein the signal provides information of an applied force on the additively-manufactured component.

Such an apparatus may further optionally include a second component, wherein the adhesive further couples the second component to the additively-manufactured component, the at least one sensor being placed in the channel after the additively-manufactured component is formed, a shape of the channel in the additively-manufactured component is configured to transmit the applied force to the sensor, the sensor being manufactured as part of the additively-manufactured component, the sensor being additively-manufactured, the sensor comprising a first material, the additively-manufactured component comprising a second material different that the first material, and the sensor comprising a Wheatstone bridge.

An apparatus in accordance with an aspect of the present disclosure may comprise an additively-manufactured component including a structure, the structure being configured to produce an indicator, and the indicator corresponding to a force applied to the additively-manufactured component.

Such an apparatus may further optionally include the structure including a lattice structure, the indicator further indicating a direction of the force applied to the additively-manufactured component, an adhesive coupled to the additively-manufactured component, the adhesive including a piezo-resistive adhesive, and the additively-manufactured component including a junction for another component.

A method in accordance with an aspect of the present disclosure may comprise additively-manufacturing a first component including a channel, arranging a sensor in the channel, the sensor including a connection point, arranging a second component proximate to the first component, and applying an adhesive in the channel, such that the additively-manufactured component, the sensor, and the second component are joined, and the connection point is accessible external to the adhesive.

Such a method may further optionally include measuring a signal applied to the sensor, wherein the signal provides information of an applied force on the additively-manufactured component, the information indicating a force applied to the channel, the second component being an additively-manufactured component, and the sensor including a strain gauge.

It will be understood that other aspects of structures and structures having sensors will become readily apparent to those of ordinary skill in the art from the following detailed description, wherein it is shown and described only several embodiments by way of illustration. As will be realized by those of ordinary skill in the art, the manufactured structures and the methods for manufacturing these structures are capable of other and different embodiments, and its several details are capable of modification in various other respects, all without departing from the disclosure. Accordingly, the drawings and detailed description are to be regarded as illustrative in nature and not as restrictive.

### BRIEF DESCRIPTION OF THE DRAWINGS

Various aspects of alloys that may be used for additive manufacturing, for example, in automotive, aerospace, and/or other engineering contexts are presented in the detailed description by way of example, and not by way of limitation, in the accompanying drawings, wherein:

FIGS. 1A-1D illustrate respective side views of a 3-D printer system in accordance with an aspect of the present disclosure.

FIG. 1E illustrates a functional block diagram of a 3-D printer system in accordance with an aspect of the present disclosure.

FIG. 2 illustrates a strain gauge in accordance with an aspect of the present disclosure.

FIG. 3A illustrates a Wheatstone bridge in accordance with an aspect of the present disclosure.

FIG. 3B illustrates a three-dimensional strain gauge in accordance with an aspect of the present disclosure.

FIG. 4 illustrates a perspective view of a vehicle chassis structure in accordance with an aspect of the present disclosure.

FIG. 5 illustrates a perspective view of the vehicle chassis structure with the outer walls removed and showing internal ribs of the structure in accordance with an aspect of the present disclosure.

FIG. 6 is a diagram illustrating an example structure prior to assembly in accordance with an aspect of the present disclosure.

FIG. 7 is a diagram illustrating the example structure in an assembled state in accordance with an aspect of the present disclosure.

FIG. 8 shows an exemplary configuration of a definition node coupled to a wheel of a vehicle in accordance with an aspect of the present disclosure.

FIG. 9 is a side view of a structure including a conventionally manufactured component with connection features and an interface node with a complementary connection feature in accordance with an aspect of the present disclosure.

FIG. 10 illustrates a short long arm (SLA) suspension geometry with an electric motor mounted to the lower control arm at the pivot axis in accordance with an aspect of the present disclosure.

FIG. 11 illustrates an example of a McPherson strut type suspension coupled to an electric motor mounted to the lower control arm at a pivot point in accordance with an aspect of the present disclosure.

FIG. 12 illustrates a subassembly in accordance with an aspect of the present disclosure.

FIG. 13 shows a flow diagram illustrating an exemplary method for manufacturing a component in accordance with an aspect of the present disclosure.

### DETAILED DESCRIPTION

The detailed description set forth below in connection with the appended drawings is intended to provide a description of various exemplary embodiments of aluminum alloys are not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those of ordinary skill in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

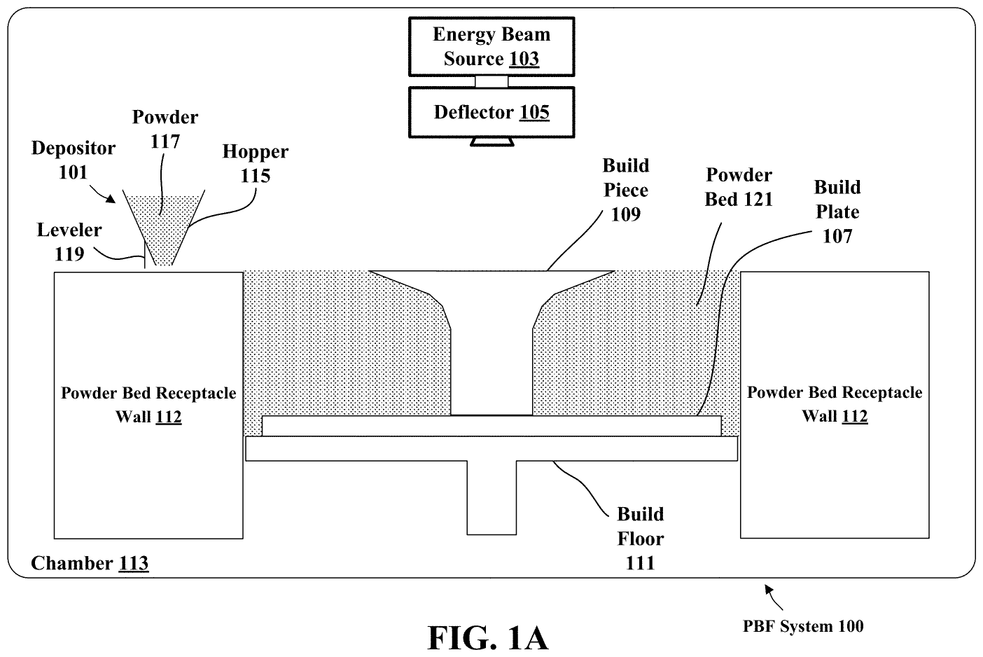

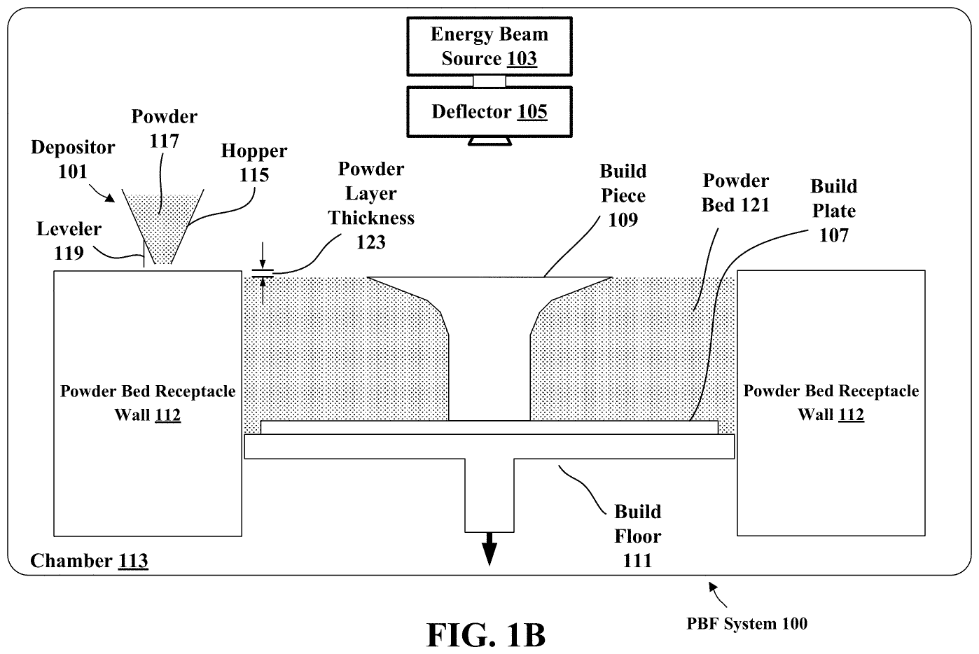

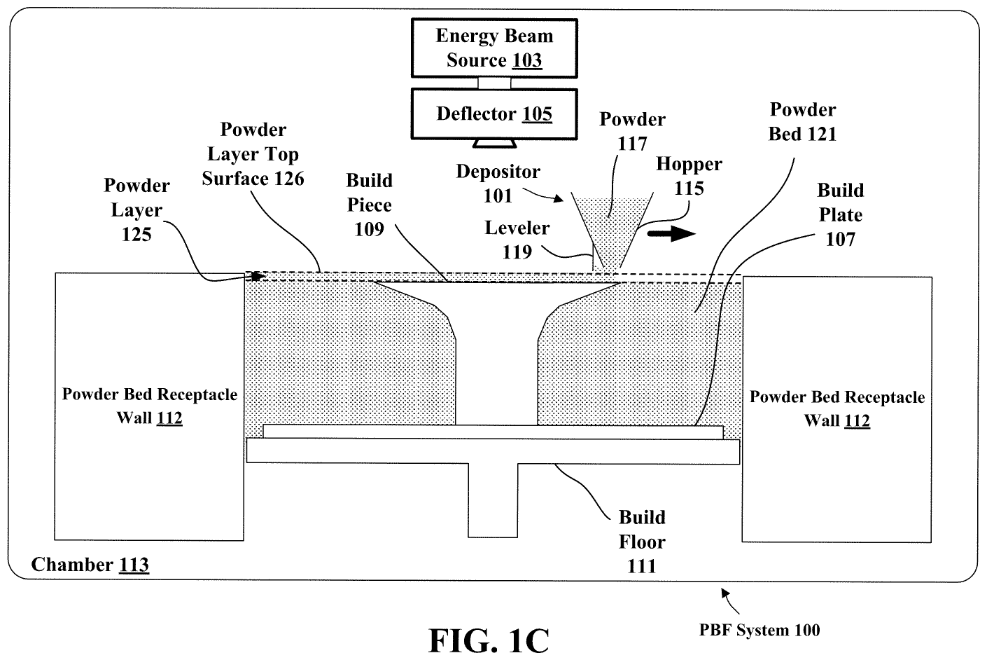

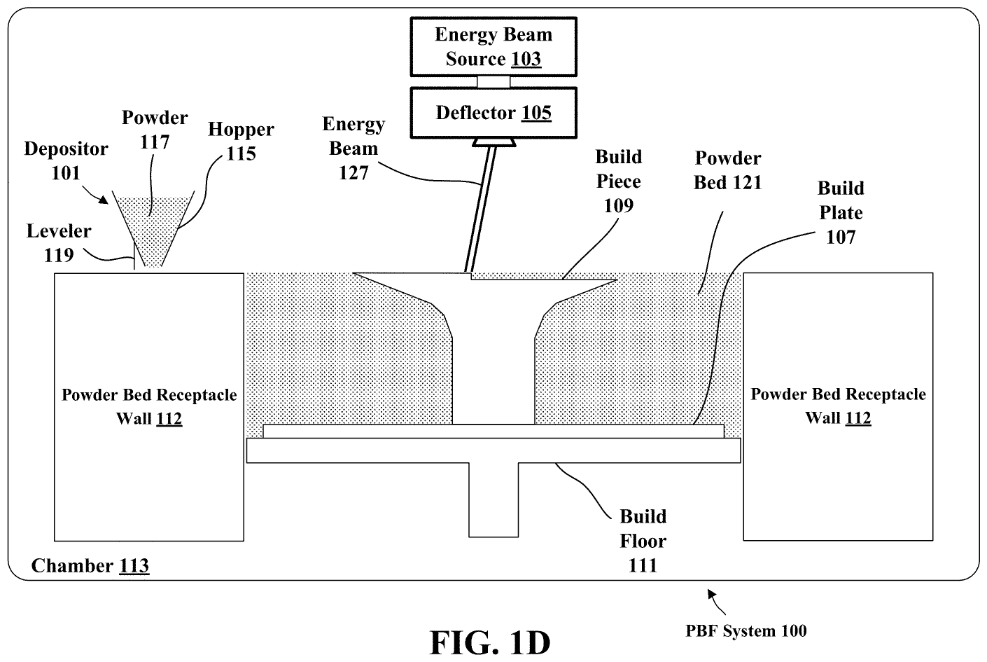

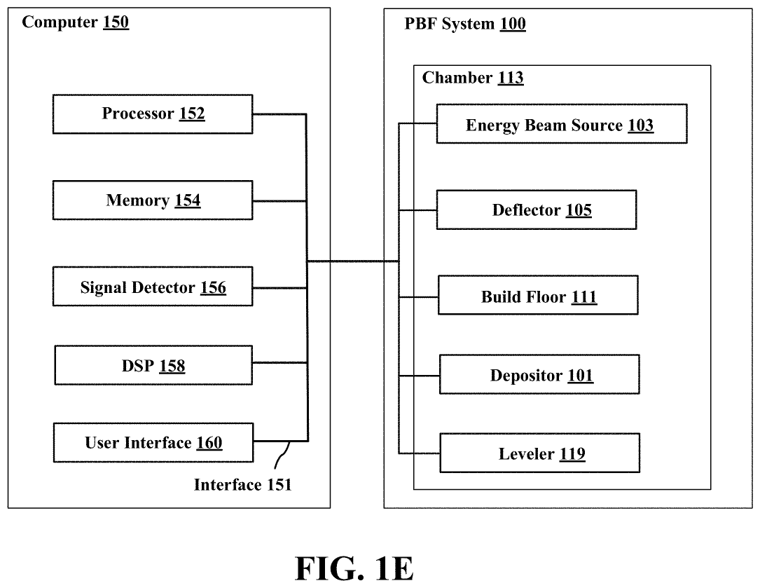

FIGS. 1A-D illustrate respective side views of an exemplary 3-D printer system.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein.

PBF System 100 may be an electron-beam PBF system 100, a laser PBF system 100, or other type of PBF system 100. Further, other types of 3-D printing, such as Directed Energy Deposition, Selective Laser Melting, Binder Jet, etc., may be employed without departing from the scope of the present disclosure.

PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

AM processes may use various metallic powders, such as one or more alloys of the present disclosure. The particular embodiments illustrated in FIGS. 1A-D are some suitable examples of a PBF system employing principles of the present disclosure. Specifically, one or more of the alloys, which may be aluminum alloys, described herein may be used in at least one PBF system 100 described in FIGS. 1A-D. While one or more alloys described in the present disclosure may be suitable for various AM processes (e.g., using a PBF system, as shown in FIGS. 1A-D), it will be appreciated that one or more alloys of the present disclosure may be suitable for other applications, as well. For example, one or more alloys described herein may be used in other fields or areas of manufacture without departing from the scope of the present disclosure. Accordingly, AM processes employing the one or more alloys of the present disclosure are to be regarded as illustrative, and are not intended to limit the scope of the present disclosure.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed herein with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and one or more user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

The processor 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117 remaining in depositor 101, leveler 119 position, and other signals. DSP 158 may be used in processing signals received by the computer 150. The DSP 158 may be configured to generate instructions and/or packets of instructions for transmission to PBF system 100.

The user interface 160 may comprise a keypad, a pointing device, and/or a display. The user interface 160 may include any element or component that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor 152 may be used to implement not only the functionality described herein with respect to the processor 152, but also to implement the functionality described herein with respect to the signal detector 156, the DSP 158, and/or the user interface 160. Further, each of the components illustrated in FIG. 1E may be implemented using a plurality of separate elements.

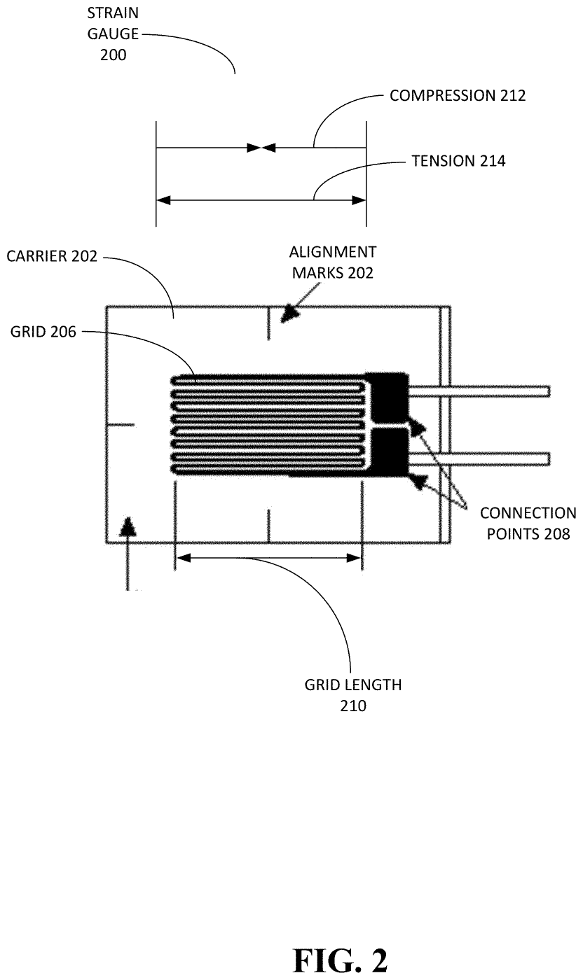

FIG. 2 illustrates a strain gauge in accordance with an aspect of the present disclosure.

Strain gauge 200 may comprise, among other things, a carrier 202, alignment marks 204, a grid 206, and connection points 208.

Carrier 202 may be a thin backing material, e.g., kapton, etc., that is attached to grid 206. Carrier 202 may be adhered to a surface to allow the strain of the component to be transferred to the grid 206.

Alignment marks 204 allow for alignment of the strain gauge 200 to be aligned with the component such that the axis of the strain gauge 200 is oriented correctly with respect to the component. Grid 206 is a conductive material, e.g., copper, aluminum, piezoresistive materials, etc., that is placed to increase the amount of conductive material in a given area that is roughly parallel to the grid length 210.

As the component coupled to strain gauge 200 experiences compression, shown as compression 212 in FIG. 2, the volume of the grid 206 wires increases slightly, which lowers the electrical resistance of grid 206. When strain gauge 200 experiences tension, shown as tension 214 in FIG. 2, the volume of the grid 206 wires decreases slightly, which increases the electrical resistance of grid 206. These changes in electrical resistance of grid 206 are proportional, and often linear, with respect to the amount of compression and/or tension experienced by strain gauge 200.

Connection points 208 provide electrical connections for wires, etc. to be coupled to strain gauge 208. Connection points 208 allow for the change in resistance or change in electrical properties of grid 206 to be measured externally, e.g., at a distance from the strain gauge 200. This change in resistance acts as an indicator to determine the amount of strain experienced by strain gauge 200. Depending on the direction of installation or printing of strain gauge 200, the indicator (voltage) may also indicate the direction of the strain experienced by strain gauge 200.

In an aspect of the present disclosure, strain gauges 200 may provide mechanical, test and/or performance feedback data on the performance of a component in a structure. Such data may allow for further refinement of design software, driving correlation, or reducing weight and size margins for various components, which may lead to more optimized structures.

Although copper is a common material used for grid 206, other materials, e.g., aluminum, other conductive materials, etc. may be used. Such materials may be additively manufactured as part of a given component, e.g., as a portion of a component surface, inside of a component, as part of a lattice structure of a component, and/or using the entire component as a strain gauge 200. Further, strain gauges 200 can be connected between various components as described herein.

In an aspect of the present disclosure, strain gauge can be additively manufactured as part of a given component or part to be used in an assembly. As such, the carrier 202 is, essentially, the component itself, and the grid 206 may be printed or otherwise added to the component being manufactured. In an aspect of the present disclosure, a component may be designed to accept a strain gauge 200 in one or more locations within the component, such that stress and strain on the component can be measured and indicated.

In an aspect of the present disclosure, optical fiber Bragg diffraction grating sensors may be used as strain gauge 200. In such an aspect, optical fibers may measure or be used to indicate a wavelength shift/offset/change when strain is applied similar to a change in electrical resistance from strain gauge 200. Optical fiber may be used to transmit UV light for UV adhesive cure. This may enable UV light transmission through the entire joint enabling some UV adhesive formulations to act as the primary structural adhesive.

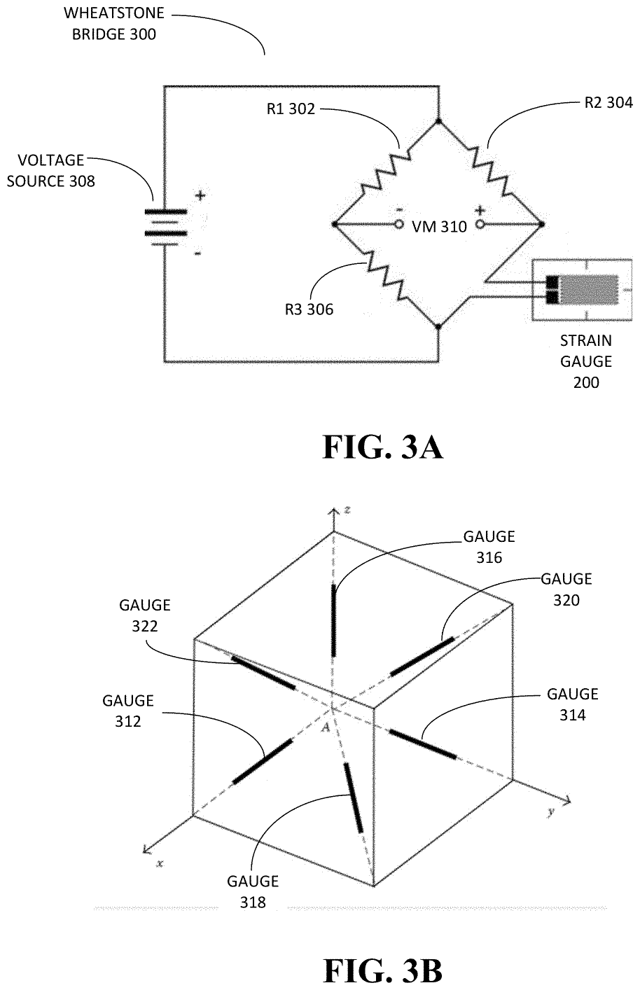

FIG. 3A illustrates a Wheatstone bridge in accordance with an aspect of the present disclosure.

Wheatstone bridge 300 may comprise, among other things, a strain gauge 200, a resistor 1 (R1) 302, a resistor 2 (R2) 304, a resistor 3 (R3) 306, and a voltage source 308. FIG. 3 illustrates a quarter bridge strain gauge Wheatstone bridge; other types of Wheatstone bridges, e.g., half bridge, temperature compensation Wheatstone bridges, etc., may also be used without departing from the scope of the present disclosure.

R1 302 and R3 306 may be referred to as the “ratio arms” of Wheatstone bridge 300. R1 302 and R3 306 may be of approximately equal value in terms of electrical resistance (ohms). R2 304 may be referred to as the “rheostat arm” of Wheatstone bridge 300. The electrical resistance of R2 304 may be set to be the same value as the electrical resistance of strain gauge 200.

When no tension or compression forces are applied to strain gauge 200, the resistance values of R1 302 and R3 306 are equal, and the resistance values of R2 304 and strain gauge 200 are equal, the measured or indicated voltage (VM) 310 will be zero, indicating that there is no force on strain gauge 200. This zero voltage, or quiescent voltage, condition at VM 310 is known as a “balanced” bridge condition. If the values of R1 302, R3 306, and/or R2 304 are different, a different voltage value will be present when the strain gauge 200 is not under compression or tension. The value of VM is an indicator of the tension or compression experienced by strain gauge 200.

As strain gauge 200 experiences tension or compression, the resistance value of strain gauge 200 changes, which changes the quiescent voltage measured or indicated at VM 310. This change in voltage indicates the type of strain (compression or tension) and the amount of such strain based on the amount of change of the voltage measured or indicated at VM 310. For example, when strain gauge 200 experiences compression 210 described with respect to FIG. 2, the value of resistance of strain gauge 200 decreases. This decrease in resistance increases the voltage value at the positive electrode of measurement point VM 310 also decreases, as the voltage drop across strain gauge 200 decreases. Since the voltage at the negative electrode of measurement point VM 310 remains the same, the value of the voltage measurement at measurement point VM 310 will be reduced by an amount proportional to the change in resistance of strain gauge 200. Similarly, if strain gauge 200 experiences tension 212 described with respect to FIG. 2, the voltage measured or indicated across VM 310 will increase, as the voltage drop across strain gauge 200 increases based on the increased resistance.

FIG. 3B illustrates a three-dimensional strain gauge in accordance with an aspect of the present disclosure.

Strain gauges 200 may be limited to measurement in one direction, i.e., in the direction of the grid length 210. However, an additively manufactured strain gauge 200 may be constructed in three dimensions, and may be integrated into a given component in one or more dimensions to allow for strain to be measured or indicated in multiple dimensions as desired. As shown in FIG. 3B, multiple gauges 312-322 may be incorporated into a given design in a “rosette” pattern or other geometries/patterns to allow for measurement of tension and/or compression in multiple dimensions. A larger or smaller number of strain gauges 200 may be incorporated without departing from the scope of the present disclosure.

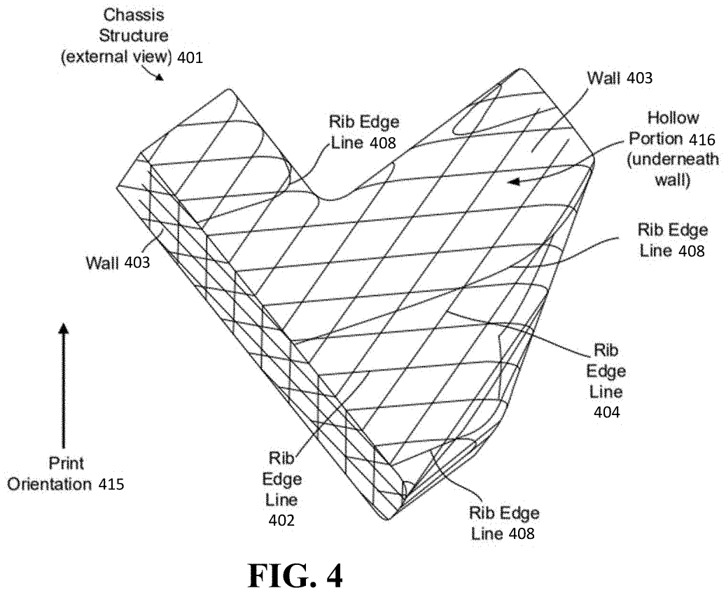

FIG. 4 illustrates a perspective view of a vehicle chassis structure in accordance with an aspect of the present disclosure.

FIG. 4 illustrates an external perspective view of a vehicle chassis structure 401 in accordance with an embodiment. Chassis structure 401 is a 3-D printed hollow structure with internal ribs. Chassis structure 401 can be formed of an alloy described herein. In an embodiment, the chassis structure 401 is a vehicle node. Chassis structure 401 includes walls 403, which are outer walls defining the external surface of the chassis structure. In other words, walls 403 represent the outer skin of the chassis structure. As such, walls 403 extend around a perimeter of the chassis structure and bound a hollow portion 416 inside the hollow chassis structure 401.

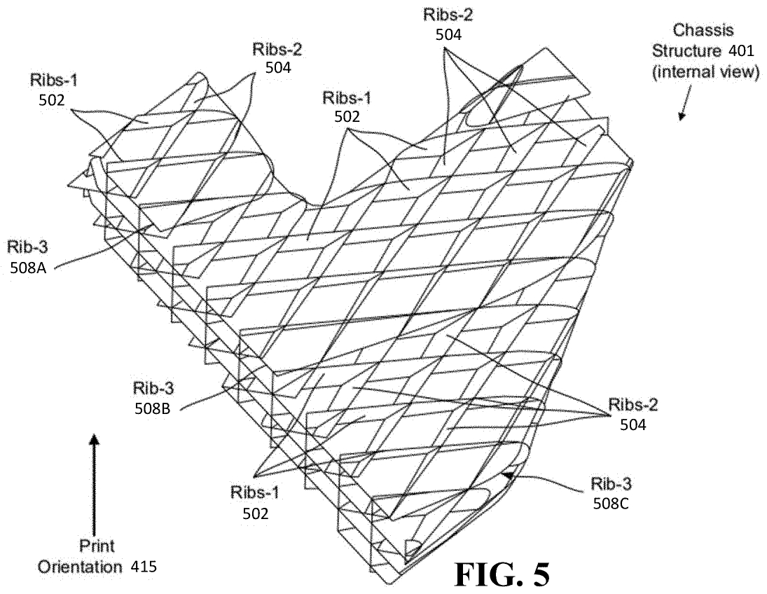

Chassis structure 401 includes internal ribs that contact an inner surface of walls 403 at rib edge lines 402, 404, and 408. In other words, rib edge lines 402, 404 and 408 show the edges of the internal ribs where the internal ribs meet the inner surface of respective walls 403. The internal ribs can be formed with the inner surface of walls 403 during the 3-D printing process, for example. The internal ribs that correspond to rib edge lines like 402, 404 and 408 can extend the full length across hollow portion 416 of the chassis structure 401, that is, the internal ribs can extend from one wall to an opposing wall on the other side of the chassis structure, as shown in more detail in FIG. 5B-D. As an example, while the volume of hollow portion 416 may vary substantially depending on the nature of the chassis structure 401 and on the target specifications for dynamic stiffness, etc., in one exemplary embodiment, the hollow portion is approximately 1000 milliliters. In other embodiments this value could be larger or smaller.

As shown in greater detail below, the ribs can include multiple sets of ribs. Here, each of rib edge lines 402, 404 and 408 belongs to a different set of generally parallel ribs. That is, in this embodiment, each set of ribs includes multiple, parallel ribs, such that each rib in a set intersects with one or more ribs in the other sets. In this way, for example, the intersections of the ribs can provide support to help allow the individual ribs to be self-supporting during the 3D printing process, such that the ribs do not need support structures during printing, and in some embodiments to help the intersecting ribs act as more effective stiffening structures when handling external loads on the chassis structure when the chassis structure is in operation. In other embodiments, additional or different criteria may be used to assist the ribs to be self-supporting as well as to allow the ribs to optimally handle external loads and attenuate high frequency plate modes. For example, placing the intersecting sets of ribs at different angles relative to one another may be another factor helping the ribs to be self-supporting, and/or helping the ribs to act as more effective stiffening structures when handling external loads. Print orientation 415 is shown to illustrate how the chassis structure and rib edge lines in FIG. 4 are aligned relative to the print orientation, as described further below. In FIG. 4, print orientation 415 is pointed upwards and generally perpendicular to a plane of the upper surface of build plate 107.

FIG. 5 illustrates a perspective view of the vehicle chassis structure with the outer walls removed showing the internal ribs in accordance with an aspect of the present disclosure.

FIG. 5 illustrates an internal perspective view of the chassis structure 101 of FIG. 4 with the outer walls 403 removed to show details of the ribs within hollow portion 416. In an embodiment, the chassis structure 401 may constitute a node. Chassis structure 401 in FIG. 5 has been topologically optimized via one or more algorithms to produce a node with a reduced mass. FIG. 5 shows a more detailed view of the internal ribs of the chassis structure 401. As indicated in FIG. 4, there exist three different internal rib sets throughout the node. More specifically, the different sets of ribs in FIG. 5 include (i) a first set of parallel ribs (i.e., ribs-1 502) which is positioned in a first direction, (ii) a second set of parallel ribs (i.e., ribs-2 504) which is positioned in a second direction such that the two sets of ribs (i.e. ribs-1 502 and ribs-2 504) intersect each other at a number of different locations throughout the chassis structure 401, and (iii) a third set of ribs (three of which are referenced as rib-3 508A, rib-3 508B and rib-3 508C) which is positioned in a direction that spans across part or all of the first two sets of ribs and therefore intersects the first two sets of ribs (i.e., ribs-1 502 and ribs-2 504) at different locations throughout the chassis structure.

As is evident from FIG. 5, each of ribs labeled rib-3 508A-C have different lengths, and therefore shorter ribs-3 508A-B do not intersect all of the ribs in the other two sets of ribs. In addition, to avoid unduly obscuring the concepts in FIG. 5A, not all ribs in all sets have been specifically identified by reference number. However, FIGS. 5B-D (below) show each individual set of ribs.

Ribs-1 502 are shown as intersecting ribs-2 504, which in turn creates a plurality of ‘diamond shaped’ pockets in the chassis structure 401. Likewise, each rib-3 508 cuts at least partially through one or more ribs in the first two sets of ribs (i.e., ribs-1 502 and ribs-2 504) to create additional pockets in lower planes of the chassis structure 401.

Producing a plurality of ribs in the third set (i.e., each rib-3 508) can be used to further support the first and second sets of ribs (i.e. ribs-1 502 and ribs-2 504). This added support can enable chassis structure 401 to use only self-supporting ribs to act as stiffening structures that meet dynamic stiffness requirements while concurrently minimizing the mass of the chassis structure 401. Chassis structure 401 is for illustrative purposes only, and other chassis structures, such as other nodes, may use fewer or more ribs in each set of ribs, as necessary, to accomplish its target goals. In addition, while three sets of ribs are shown in FIG. 5, in other embodiments a different number of sets of ribs is also possible. Referring still to FIG. 5A-D, it can be appreciated that eliminating the requirement of supports in the 3-D printing also minimizes post-processing time, at least because there are no support structures that require separation and removal. Further, the wall thickness can be dramatically reduced—on the order of 1 to 2 millimeters or less—when using 3-D printing as compared to the current casting or extrusion techniques commonly used to make these types of chassis structures.

One advantage of the chassis structure 401 is that each of the ribs in all three sets is self-supporting. Further, in various embodiments, each of the ribs can be used as stiffening structures for attenuating high plate nodes, without any rib in the chassis structure 401 being used solely for supporting a wall during 3-D printing. Further, because the ribs may be used also to support the walls 403 during 3-D printing concurrent with their use as stiffening structures when in operation, the use of the self-supporting ribs effectively eliminates the need for external support structures, e.g., to support the walls 403 during 3-D printing. Another advantage of the chassis structure 401 in FIGS. 4 and 5 is that the mass of the chassis structure 401 can be dramatically reduced due to the thinner walls that can be used (e.g., 1-2 millimeters (mm) or less). The number, thickness and orientation of the ribs may also be optimally selected to minimize overall mass of the chassis structure 401. For example, the ribs can in various embodiments be made with a thickness of about 1-4 millimeters (mm), or less.

In an aspect of the present disclosure, strain gauges 200 may be printed as part of or later added to ribs-1 502, ribs-2 504, and/or ribs-3 508, which may use the lattice structure to determine the three-dimensional strain on structure 401.

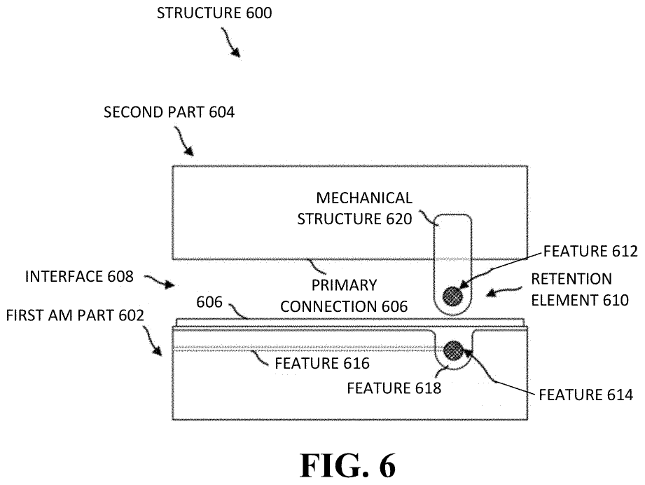

FIG. 6 is a diagram illustrating an example structure prior to assembly in accordance with an aspect of the present disclosure.

FIG. 6 is a diagram illustrating an example structure 600. The example structure 600 illustrated in FIG. 6 includes a first additively manufactured (AM) part 602 configured to connect to a second part 604 via a primary connection 606 applied to an interface 608 between the first AM part 602 and the second part 604. The additively manufactured part can be formed of one or more of the alloys described herein.

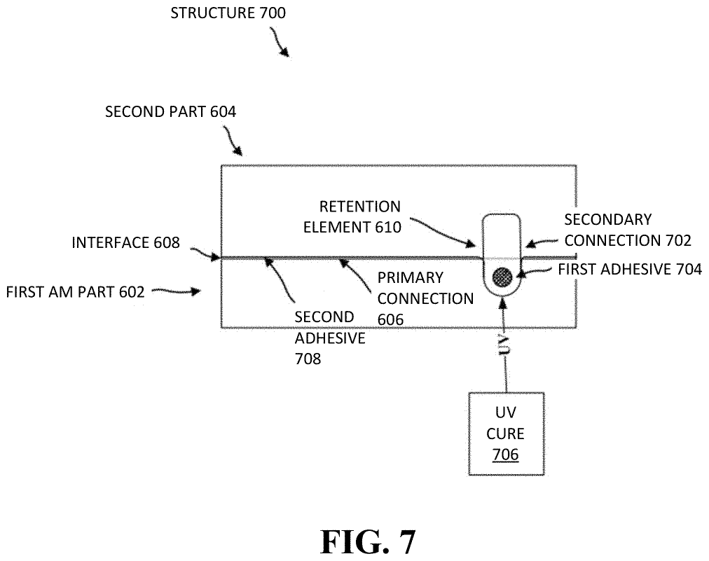

In an aspect, at least one retention element 610 including a secondary connection 702 (see FIG. 7). The secondary connection 702 including a first adhesive 704 (see FIG. 7) configured to secure the first AM part 702 and the second part 704. The secondary connection is located to provide a connection between the first AM part 702 and the second part 704.

FIG. 7 is a diagram illustrating the example structure in an assembled state in accordance with an aspect of the present disclosure.

FIG. 7 is a diagram illustrating the example structure 700 in an assembled state. The example structure 700 illustrated in FIG. 7 includes the first AM part 602 connected to the second part 604 via the primary connection 606 applied to the interface 608 between the first AM part 602 and the second part 604.

In an aspect, the at least one retention element 610 including a secondary connection 702. The secondary connection 702 including a first adhesive 704 configured to secure the first AM part 602 and the second part 604. The secondary connection may be located to provide a connection between the first AM part 602 and the second part 604.

The example structure 600 may include a first additively manufactured (AM) part 602 and at least one retention element 604. The first AM part 602 may be a node, a subcomponent of a node, or other type of component. The AM part 602 may be printed through any conventional means including, for example, via PBF. The PBF printing may be performed using any technology suitable for use in PBF printing. These technologies may include, for example, selective laser melting (SLM), selective laser sintering (SLS), selective heat sintering (SHS), electron beam melting (EBM), direct metal laser sintering (DMLS), and others. In other embodiments, the AM part 602 may be printing using a different 3-D print technology such as fused deposition modeling (FDM). FDM AM may be ideal for printing various plastics, thermoplastics, etc. In general, the AM part 602 may be additively manufactured using any known AM technique or techniques.

One advantage of the use of AM in combining parts is that, due to the design flexibility of AM, the AM part 602 may include various features 612, 614, 616 that may, in turn, be used in conjunction with the adhesive-based part retention. For example, AM may be used to generate features 612, 614 that are adhered together, features 616 that carry adhesive to a location or locations (e.g., primary connection 606 and/or retention element 610, feature 614) where the AM part 602 may be adhered to another part 604, or a combination of both of these (e.g., features 612, 614, 616). Furthermore, adhesive-based part retention may be combined with mechanical-based part retention. For example, primary adhesive-based part retention may be combined with mechanical-based part retention. Secondary adhesive-based part retention (e.g., holding parts together while a primary adhesive is applied, dries, and/or cures) may be combined with mechanical-based part retention. Some combination of primary adhesive-based part retention and secondary adhesive-based part retention may be combined with mechanical-based part retention. Mechanical-based part retention may include, for example, groove that retains a snap-ring, screw and shim, spring-loaded clips, clips, a snap-like part retention element, snap-like part retention feature slidably engaging with a receptacle on an another part, a Christmas tree fastener, magnets, a tongue and groove connection, or other mechanical-based connections.

In an example, the first AM part 602 may be configured to connect to a second part 604. The second part 604 may include, for example, an AM part, a tube, a panel, an extrusion, any other type of conventionally-manufactured part, or a COTS part. Thus, structures formed may be manufactured by bonding together, for example, two (or more) AM parts (e.g., where one AM part may be considered the first AM part), or an AM part (e.g., where the AM part may be considered the first AM part) and a tube, panel, extrusion, or any other type of conventionally-manufactured part, or a COTS part.

The connection between the first AM part 602 and the second part may be via a primary connection. For example, the primary connection may include a primary adhesive for bonding the structures together. The primary connection may be applied to an interface between the first AM part 602 and the second part 604. For example, the primary adhesive may be applied at primary connection 606 at interface 608.

A part retention feature (e.g., part retention element 610) may, in some embodiments, be temporary and may be removed after the primary adhesive bond between the structures is formed. Adhesive(s) may also be used for the part retention features. For example, at least one retention element may be included. The at least one retention element may include a secondary connection 702. The secondary connection 702 may include an adhesive configured to secure the first AM part 602 and the second part 604. Furthermore, the secondary connection 702 may be located to provide a connection between the first AM part 602 and the second part 604.

In an aspect, the first adhesive includes a hot melt material applied between a first mechanical feature 614 associated with the first AM part 602 and a second mechanical feature 612 associated with the second part 604. The hot melt material may include any form of hot melt adhesive, hot melt glue, or another thermoplastic adhesive. Generally, however, the hot melt adhesive, hot melt glue, or another thermoplastic adhesive may be quick curing such that hot melt adhesive, hot melt glue, or another thermoplastic adhesive. Accordingly, the hot melt material may be a quick curing adhesive or a quick curing sealant.

In an aspect, hot melt material may be used. The hot melt material may be a quick curing adhesive or sealant that may be applied to the mechanical features on two components to be connected. The features may have an increased surface area. The increased surface area may enable sufficient bond strength to retain the two (or more) parts being connected. Once the hot melt retention fluid cures, adhesive may be injected between the nodes being connected. The cured hot melt feature would ensure that the two parts 602, 604 are retained during the adhesive injection process. The retention force (i.e., the force provided by the hot melt holding the two nodes together) would be higher than the adhesive injection force, thereby securely holding the parts 602, 604 in the proper orientation and with the required separation distance to ensure repeatable bonds.

In an aspect, the first adhesive includes an ultraviolet (UV) cured adhesive applied between a first mechanical feature associated with the first AM part 602 and a second mechanical feature associated with the second part. UV cure systems 706 may be utilized as part retention features. In this embodiment, adhesives at the retention features would be UV cured such that they are held in place during the adhesive injection and curing process. The UV cure adhesives would be applied at strategic locations to provide sufficient retention force. The UV cure adhesive would be configured to cure prior to the adhesive injection and curing.

In an aspect, the primary connection 606 between the first AM part 602 and the second part 604 includes a second adhesive 708. For example, a secondary adhesive may be between the first AM part 602 and the second part 604 where the first AM part 602 and the second part 604 meet, e.g., as illustrated in FIG. 7.

In an aspect, the first adhesive 704 is faster curing than the second adhesive 708. For example, as discussed herein, hot melt material such as, hot melt adhesive, hot melt glue, or another thermoplastic adhesive that may be quick curing may be used as the first adhesive 704. The second adhesive 708 may cure more slowly.

In an aspect, the secondary connection 702 further includes a mechanical structure (e.g., making up retention element 610). For example, the secondary connection may include both an adhesive and mechanical-based part retention. Mechanical-based part retention may include, for example, groove that retains a snap-ring, screw and shim, spring-loaded clips, clips, a snap-like part retention element, snap-like part retention feature slidably engaging with a receptacle on another part, a Christmas tree fastener, magnets, a tongue and groove connection, or other mechanical-based connections that may be used in addition to the adhesive.

In an aspect, the mechanical structure may be integrated with at least one of the first AM part 602 and the second part 604. For example, mechanical structure 618 may be integrated with the first AM part 602. Mechanical structure 620 may be integrated with the second part 604.

In an aspect, the mechanical structure is co-printed with at least one of the first AM part 602 and the second part 604. For example, mechanical structure 618 may be co-printed with the first AM part 602. Mechanical structure 620 may be co-printed with the second part 604.

In an aspect, the mechanical structure is separate from the first AM part 602 and the second part 604. For example, mechanical structure 618 may be attached to the first AM part 602 after the first AM part 602 is manufactured. Mechanical structure 620 may be attached to the second part 604 after the second part 604 is manufactured.

In an aspect of the present disclosure, strain gauges 200 may be printed as part of one or more parts 602 and/or 604, and coupled between parts 602 and 604 as desired.

In an aspect of the present disclosure, adhesives used to bond first part 602 and second part 604 may be used to insulate the strain gauge 200 from one or more parts of the overall structure. If the strain gauge 200 is co-printed as part of first part 602, first part 602 may be used as a strain gauge, either partially or in its entirety.

In an aspect of the present disclosure, the primary connection 606 may act as a location for strain gauge 200, as adhesives may act as insulation between first part 602 and second part 604. Adhesives that responds to electricity as a curing method may be used. Higher conductivity metals like copper may be deposited into the base of a joint or interface 606 and may be charged for cure. In an aspect of the present disclosure, adhesives may be doped with conductive elements to provide grounding of the strain gauge 200.

In an aspect of the present disclosure, the structure of strain gauge 200, along with adhesives used as insulators, may provide capacitive storage within the structure 600. Further, adhesives used within strain gauges 200 may be made from piezoresistive materials, such as graphene oxide added to the adhesive formulation. The conductive material may be evenly spaced by adding a dispersant, allowing for primary connection 606 to act as a conductive element via the tunnel effect.

The variability of the electrical resistance in a production of parts may be controlled through monitoring of adhesive dispensed into the primary connection 606 or wherever strain gauge 200 may be desired in structure 600. Structural adhesives, and/or UV adhesives, may be employed in this matter without departing from the scope of the present disclosure.

In an aspect of the present disclosure, strain gauge 200 may be included the primary interface 606 or the secondary connection 702. This may be achieved by adding strain gauges 200 directly into the adhesive which is then applied to the joint groove or adding strain gauges 200 into the joint that are not mixed into the adhesive.

In an aspect of the present disclosure, robotic vision systems used in assembly processes may capture printed feature/guideline for positioning of the strain gauges 200. In some embodiments, recesses may be provided in the joint section/part to accept the strain gauge 200.

In an aspect of the present disclosure, strain gauges 200 may be added to the adhesive directly. Glass balls with a diameter of approximately 100 microns-1 mm may be added to the adhesive. In other embodiments, wireless sensors may be used that are within a similar size range. Wireless temperature sensors may also be used without departing from the scope of the present disclosure.

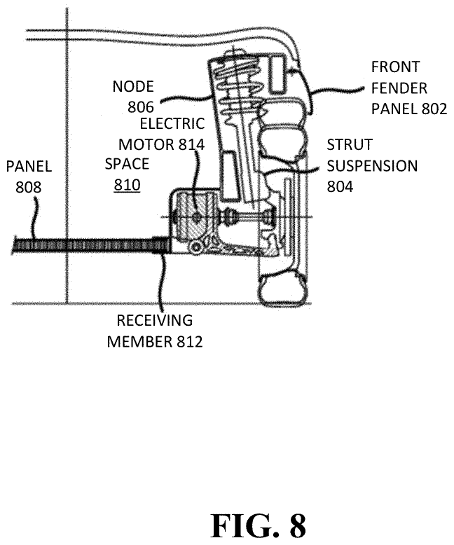

FIG. 8 shows an exemplary configuration of a definition node coupled to a wheel of a vehicle in accordance with an aspect of the present disclosure.

FIG. 8 is a representative example of a definition node coupled to a wheel in a steer/drive configuration. Space 810 is the storage compartment, and represents saving of space for cargo by judiciously packaging the EV elements. Honeycomb sandwich panel 808 is shown extending into a receiving member 812. The body of the node 806 is coupled on one side to front fender panel 802. The lower portion of node 806 is coupled in this embodiment to a McPherson Strut Suspension 804 with integrated electric drive. The electric motor 814 can be seen compactly packaged in the underbody and packaged adjacent node 806. Other embodiments are equally possible depending on the type of vehicle, the mechanism of propulsion, etc.

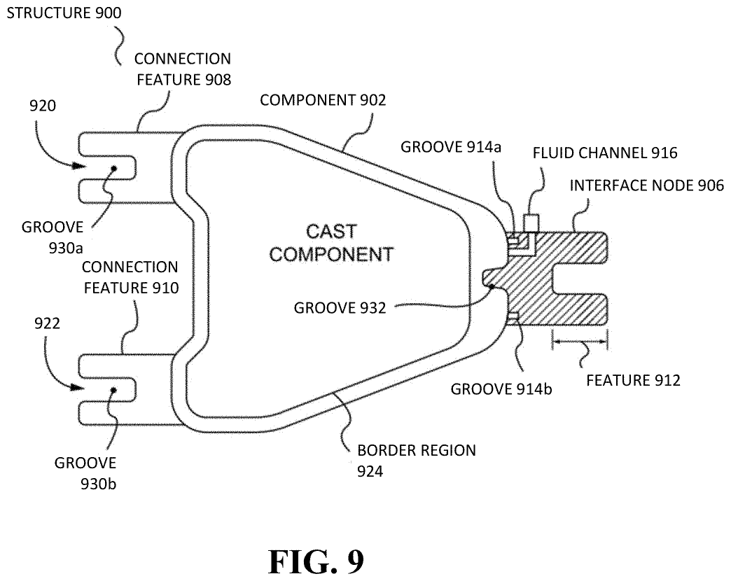

FIG. 9 is a side view of a structure including a conventionally manufactured component with connection features and an interface node with a complementary connection feature in accordance with an aspect of the present disclosure. FIG. 9 is a side view of a structure 900 including a conventionally manufactured component 902 with connection features and an AM Interface Node 906 with a complementary connection feature. Component 902 is illustrated as a cast component, but in general component 902 may be machined or manufactured using another conventional technology amenable for relatively high throughput production. In other embodiments, component 902 may be manufactured using a generally higher throughput AM technique such as DED. In an exemplary embodiment, cast component 902 includes a voluminous chunk of cast aluminum or plastic, although other materials are also possible. Cast component 902 may be useful to provide a structure that incorporates a body of dense material, such as an impact structure in a vehicle. However, component 902 is not so limited, and other geometric configurations are possible. By way of example, cast component 902 may be made hollow and consequently may serve as a cover for another part, or a case for a more sophisticated structure (e.g., a gear case).

At the border region 924 of cast component 902 are connection features 908 and 910. In an exemplary embodiment, connection features 908 and 910 are part of cast component 902 and are cast or machined together with the rest of the component 902. In other embodiments, connection features 908 and 910 may be parts of other components, including, for example, Interface Nodes. In this former embodiment wherein the features 908 and 910 are included within the component 902, connection features 908 and 910 may be made of the same material (e.g., aluminum, plastic, etc.) and in this event they are subject to the same thermal constraints as that material. This fact may be taken into consideration in determining whether connection features 908 and 910 can be used in an environment containing significant amounts of thermal energy. In general, whether or not the connection features 908, 910 are part of the cast component 902, they may be connected to other components, including standard AM joints, other AM Interface Nodes, etc. Connection features 908 and 910 are negative features because they include respective grooves 930a and 930b. Thus, connection features 908 and 910 in this embodiment are configured to engage with complementary features that use positive connection features. These prospective engagements with connection features 908 and 910 are shown by respective arrows 920 and 922.

FIG. 9 also includes groove section 932 adjacent border region 924 of cast component 902. Thus, inset into cast component 902 is a negative connection feature for providing a connection to an AM Interface Node 906. Interface Node 906 is shown connected to cast component 902 using a positive complementary connection feature, i.e., the tongue that protrudes into groove 932. Furthermore, using a suitable AM technique, the thermal properties of node 906 can be carefully controlled. It is noteworthy that in many embodiments, FIG. 9 is not drawn to scale and cast component 902 may be significantly larger and more voluminous relative to node 906 than shown in the figure. (In other embodiments, the difference may be less significant or they may be comparable in size). Accordingly, rather than building an entire voluminous component 902 that includes these thermal requirements, the thermal characteristics are instead incorporated into a relatively small Interface Node 906. A substantial amount of powder may be saved in the process. In addition, titanium, which is expensive, need not be used unnecessarily in volume.

Interface Node 906 may be connected to cast component 902 via the tongue connection at groove 932 (as noted) together with the surface regions of component 902 adjacent groove 932 that contacts Interface Node 906. The negative connection feature including groove 932 may be engaged with the complementary, positive connection feature of Interface Node 906 via an appropriate adhesive. In this exemplary embodiment, precision fluid ports with fluid channels 916 (only one shown) may be built into Interface Node 906 to supply an adhesive and on an opposing side, to provide negative pressure in order to promote distribution and spread the adhesive. Interface Node 906 may also provide sealant grooves 914a and 914b or similar structures to provide a sealant to facilitate proper distribution of the adhesive. In addition, spacers or other structures (not shown) may be incorporated into the connection feature on the Interface Node 906 to prevent galvanic corrosion when certain dissimilar materials are involved. In another embodiment, channel 916 may instead be part of a network of cooling channels in Interface Node 906 for delivering fluid to and from the cast component 902 to carry thermal energy away. Additionally, Interface Node 906 may itself be composed of a material configured to dissipate thermal heat from cast component 902. In this case, Interface Node 906 may be made of a material with a significantly high melting point to accommodate the direct connection to cast component 902.

In this example, Interface Node 906 removes complexities from the cast component 902. Interface Node 906 incorporates the complex thermal features that otherwise would be necessary for integration into at least a region of cast component 902. This saves manufacturers from having to make changes to the cast or to add the necessary complexity to whatever conventional technique is used, tasks which would otherwise increase lead times and lower throughput. Interface Node 906 also incorporates the complex fluid ports 916 and other potential structures in order to ensure a secure a proper seal to cast component 902, thereby reducing or eliminating the need for cast component 902 to embody these features.

Interface Node 906 also includes on the other end an additional negative connection feature 912, which may constitute any node-based connection. For example, connection feature 912 may be configured to connect the node 906 to any suitable structure. For example, node 906 may be connected to connecting tubes, panels, and other structures. In addition, the structure comprised of node 906 and component 902 may be one of two or more, or a network of, similar structures which may all be connected together through connection features similar to connection feature 912.

The Interface Node 906 illustrated in FIG. 9 may in other embodiments incorporate a multi-material complexity in that it may have been 3-D printed with different types of materials and potentially in different proportions to serve a specific purpose. In the embodiment shown, node 906 may incorporate a thermal complexity as in the case described herein, where a higher melting point may be desirable to maintain the structural integrity of node 906 and protect that of component 902 from a heat source. However, it will be appreciated that in other embodiments, Interface Node 906 may incorporate other functions, structures, and features, as well as additional connection features (that may otherwise have had to be included in component 902) to enable node 906 to connect to a number of other standard interconnects. In this respect, Interface Node may incorporate a larger number of complexities in a manufactured component, rendering them unnecessary to place in the latter. This capability exploits the advantages of AM in a way that obviates a potentially significant amount of complex machining that may otherwise have to be performed in constructing these conventionally manufactured or higher throughput manufactured components. Further, in an exemplary embodiment, because use of the 3-D printer is not necessary for the conventionally manufactured components that incorporate the large volumes, but use of AM is only needed for the node itself, time and material may be saved in the AM process. A higher manufacturing throughput may consequently be obtained.

In addition, the connection feature 912 on the Interface Node and the connection feature defined by groove 932 on the cast component need not be a tongue and groove structure, and other connection features may be equally suitable. For example, the connection feature 912 may in an alternative embodiment include a pair of tube-like protrusions having an inner and an outer diameter, the smaller protrusion inside the larger protrusion, for enabling a connection to carbon fiber connecting tubes, thereby coupling the connecting tubes to the cast component 902 via Interface Node 906. More generally, on the end of the Interface Node where connection feature 912 currently resides, features may be incorporated to enable connection to any other component, including for example, extrusions, other nodes, other castings, etc. In an embodiment, a plurality of node-casting interfaces as described herein may be used to form a chassis for a transport structure. In this embodiment, the type of component 902 may vary from region to region of the vehicle, and may not be used wherever not needed. In other embodiments, a single Interface Node may include a plurality of interfaces 912 for multiple connections.

In an aspect of the present disclosure, interface node 906 may include one or more strain gauges 200 as described with respect to FIGS. 2, 3A, and 3B. In an aspect of the present disclosure, interface node 906 may be printed using multiple materials, or printed in zones, to allow for electrical isolation of strain gauges 200 as desired. In such an aspect, strain gauges 200 may be integrated directly into interface node 906.

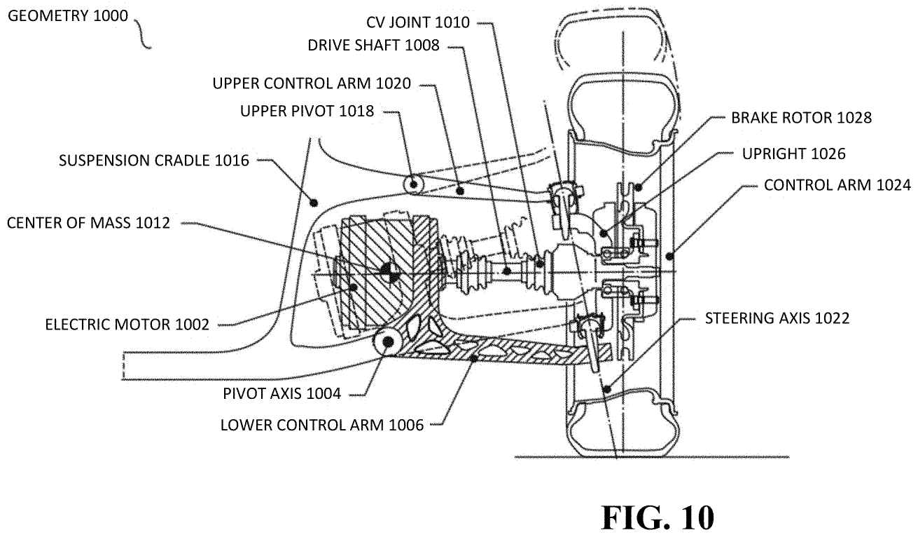

FIG. 10 illustrates a short long arm (SLA) suspension geometry with an electric motor mounted to the lower control arm at the pivot axis in accordance with an aspect of the present disclosure.

FIG. 10 illustrates a short long arm (SLA) suspension geometry 1000 with an electric motor 1002 mounted to the lower control arm 1006 at the pivot axis 1004. Conventionally, in electric powered vehicles, the motors are often located at the center of the front or rear axles. In some cases, the motors are incorporated into the wheel hubs. In the example of FIG. 10, the electric motor 1002 is mounted close to the lower control arm pivot 1004 and rocks with the suspension system as it travels into jounce and rebound. Although there is some inertia involved, the increase in unsprung mass is minimal as compared to a hub motor because the motor travel is minimized. A key advantage to this concept, therefore, is that it provides package efficiency without negatively affecting vehicle handling. The motor 1002 is connected to the drive wheel hub via a short drive shaft 1008 with constant velocity (CV) joints 1010 to accommodate any angular changes between the wheel hub and the control arm/motor. The motor housing can be additively manufactured together with the lower control arm 1006 to create a full optimized housing. The motor housing may include the features discussed herein as well as the motor's center of mass 1012, the vehicle structure/suspension cradle 1016, the upper pivot 1018, the upper control arm 1020, the steering axis 1022, control arm 1024, upright 1026, and brake rotor 1028.

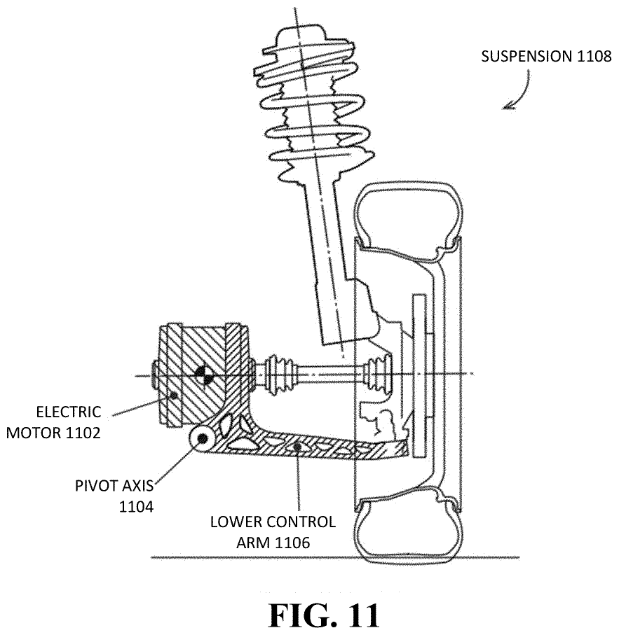

FIG. 11 illustrates an example of a McPherson strut type suspension coupled to an electric motor mounted to the lower control arm at a pivot point in accordance with an aspect of the present disclosure.

FIG. 11 illustrates a McPherson strut type suspension 1108 with an electric motor 1102 mounted to the lower control arm 1106 at the pivot axis 1104. It should be noted that this control arm mounted motor system will work with any suspension system in which the control arm pivot is perpendicular to the wheel rotation axis. In an exemplary embodiment, one or more of these parts may be additively manufactured an included as a modular component in the vehicle frame.

In an aspect of the present disclosure, strain gauges 200 may be printed as part of upper control arm 1020, control arm 1024, lower control arm 1106, or other parts of various structures. In such an aspect, road load inputs in a vehicle structure via sensorized suspension elements may be captured and used for performance data, design data, or other uses.

In an aspect of the present disclosure, strain gauges 200 may be used as wheel force transducers, and may be integrated on the wheel hub in order to capture all three forces and moments on the rotating wheel. To install such transducers externally on wheels may be expensive and require additional fixturing in order to mount onto a vehicle.

Road load data may be captured for testing as well as throughout the life of a vehicle, which may be used for health monitoring of the vehicle, derivation of duty cycles for future vehicles, localization of warranty/insurance as it enables vehicle manufacturers to accurately acquire driving conditions and driver responses in different geographic locations, correlation of parts across entire production volume, and other purposes.

By incorporating instrumentation directly into the suspension or by calibrating the suspension elements themselves into a precision instrument, an aspect of the present disclosure allows for the capture of road load data and/or wheel force transducers while reducing the cost prohibitiveness and extra assembly. In an aspect of the present disclosure, the strain response of the suspension elements can be calibrated to a road profile matrix and therefore derive a road load input from any given event. In such an aspect, a test vehicle can be cycled through the entire range of expected loads, and calibration matrices and curves can be developed for the design. These calibration matrices would be directly integrated into the ECU of the vehicle, and may be used to derive the road load inputs as the vehicle is in use.

In an aspect of the present disclosure, insulation may be introduced into one or more components by using a secondary non-conductive coating on 3D printed metal, such as e-coating. In such an aspect, a dispensing system may be used that has the ability to provide 2 (or more) uncured adhesives at the same time. This may take the form of individual placement of adhesive at one time followed by placement of the next adhesive. Dispensing might also occur by ejecting one adhesive within the jet of the other adhesive, leading to an embedded adhesive system. In such an embodiment, the embedded adhesive might have the potential of electrical conductivity while remaining isolated from the conductive body of the printed parts. The geometry of 2 adhesive dispense solution may be structured such that on insertion of the tongue in a groove of a mating part the structure of adhesive-in-adhesive is not broken.

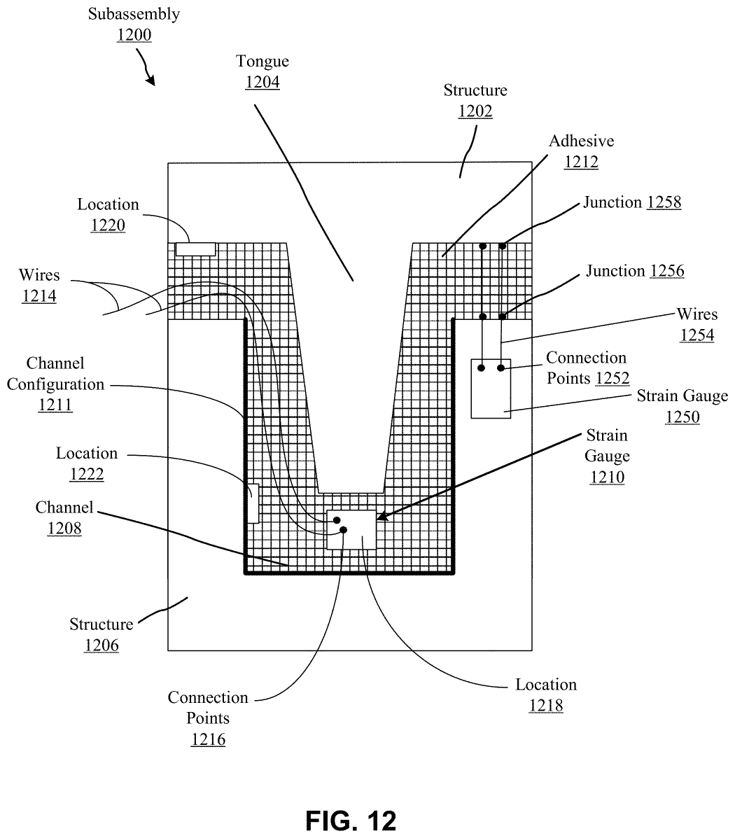

In an aspect of the present disclosure, the conductive bond may generate electricity by movement of external part, to provide electricity for general consumption or for running an embedded device. Thermally conductive adhesives may be included either alone or in conjunction with electrical conductivity. Thermal conductivity of joints may enable heat dissipation from one part to another, reducing temperature distortion of individual parts. The mechanical stability and/or health of joints within a given structure may also be monitored. If electrical connectivity is lost or changed, a signal can be sent to indicate a problem with a joint within the structure. For example, a smart car may continuously monitor the health of all joints. Part-to-part electrical conductivity can be achieved by soft wires printed on the tongue and/or groove of various parts within a structure, which make contact upon insertion. In an aspect of the present disclosure, non-printed devices may be placed in the print chamber/platform during the 3D printing process. Structural containment of the devices within the part may be achieved by printing. In such an aspect, pre-manufactured strain gauges may be enclosed within a printed part that may not be otherwise be able to be placed in machined parts. FIG. 12 illustrates a cross-sectional view of a tongue and groove connection in accordance with an aspect of the present disclosure.

FIG. 12 illustrates a subassembly 1200, including structure 1202 having a tongue 1204 coupled to a structure 1206 having a channel 1208 (also referred to as a groove), with strain gauge 1210 between structure 1202 and structure 1206. Structure 1202 and structure 1206 are coupled with adhesive 1212. Strain gauge 1210 may be arranged in one or more channels 1208 of the adhesive sections of structure 1202 and structure 1206.

In an aspect of the present disclosure, strain gauge 1210 can be placed in the joint sections, e.g., channel 1208 of structure 1206, prior to adhesive 1212 application. In an aspect of the present disclosure, strain gauge 1210 can be attached within a channel 1208, or be coupled across a tongue 1204/channel 1208 connection, as desired. Strain gauge 1210 connection points 1216 can be accessed through wires 1214 coupled to connection points 1216, which may also run within a channel 1208 and/or across a channel 1208/tongue 1206 connection as desired. As such, connection points 208 can be accessed anywhere outside of the structure 1200, external to the adhesive 1212, etc., such that measurements of strain gauge 1210 may be taken. As shown in FIG. 12, adhesive 1212 may couple strain gauge 1210 to structure 1206, structure 1202, and/or subassembly 1200. Further, strain gauge 1210 may be added to channel 1208 after structure 1206 is printed or formed.

In an aspect of the present disclosure, measurement or indication of the forces experienced by strain gauge 1210 may allow for improvements in design of one or more of the structures 1202 or 1206, or allow for determination of the amount of forces experienced at various points within subassembly 1200.

As described herein, the strain gauge 1210 may be manufactured as part of structure 1206, or may be a separately manufactured part. In either embodiment, strain gauge 1210 may be made of the same material as structure 1206, or may be made of a different material as desired.

In an aspect of the present disclosure, the shape of channel 1208, i.e., channel configuration 1211, may be designed or configured to assist in transmission of forces from subassembly 1200, structure 1202 and/or structure 1206 to strain gauge 1210. For example, and not by way of limitation, a portion of channel 1208 may be configured to be along a direction of force expected in subassembly 1200, and strain gauge 1208 may be placed in that portion of channel 1208 in order to measure or indicate the forces in that portion of channel 1208. As such, although channel configuration 1211 is shown as a “U” cross-sectional shape in FIG. 12, any shape or configuration may be used for channel configuration 1211 without departing from the scope of the present disclosure.

In an aspect of the present disclosure, the direction of channel 1208, and/or the placement of strain gauge 1210 in channel 1208, may assist in the determination of the direction of forces exerted on subassembly 1200. For example, and not by way of limitation, strain gauge 1210 may be placed in multiple locations, e.g., location to assist in the measurement or indication of forces in various directions within channel 1208, along channel 1208, etc.

As described herein, strain gauges may be additively manufactured as part of structure 1206. As shown in FIG. 12, strain gauge 1250 may be an additively manufactured strain gauge manufactured or co-printed with structure 1206. Connection points 1252 and wires 1254 may be additively manufactured along with structure 1206, or may be coupled to strain gauge 1250 at a later time in the assembly of subassembly 1200.

In an aspect of the present disclosure, one or more junctions 1256 may be manufactured as part of structure 1206, such that strain gauge 1250 and/or connection points 1252 may be accessed externally from structure 1206. In an aspect of the present disclosure, junction 1256 may be coupled to junction 1258, which may be part of another structure 1202, or even another subassembly 1200. Further, junction 1256 and junction 1258 may be electrically coupled across adhesive 1212 if desired. Depending on the adhesive used for adhesive 1212, e.g., piezoresistive adhesives, the junctions 1256 and 1258 may provide indicators of forces experienced along channel 1208 or in certain portions of channel 1208 based on the electrical connections of structure 1202, structure 1206, junctions 1256 and 1258, and/or the types of adhesive 1212 used in subassembly 1200.

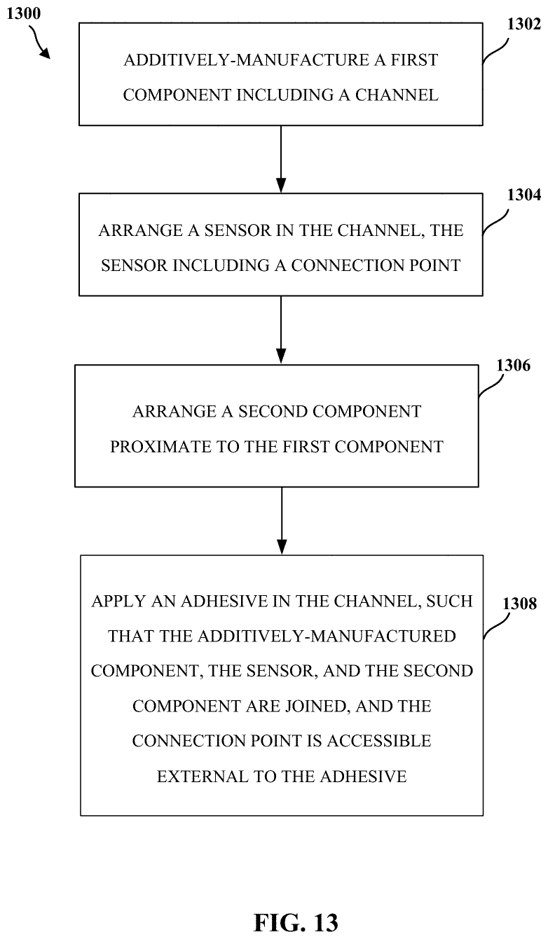

FIG. 13 shows a flow diagram illustrating an exemplary method for additively manufacturing a component in accordance with an aspect of the present disclosure

FIG. 13 shows a flow diagram illustrating an exemplary method 1300 for additively manufacturing a component in accordance with an aspect of the present disclosure. The objects that perform, at least in part, the exemplary functions of FIG. 12 may include, for example, computer 150 and one or more components therein, a three-dimensional printer, such as illustrated in FIGS. 1A-E, and other objects that may be used for forming the above-referenced materials.

It should be understood that the steps identified in FIG. 13 are exemplary in nature, and a different order or sequence of steps, and additional or alternative steps, may be undertaken as contemplated in this disclosure to arrive at a similar result.

At 1302, a first component is additively-manufactured including a channel.

At 1304, a sensor, such as a strain gauge 200, is arranged in the channel, the sensor including a connection point.

At 1306, a second component is arranged proximate to the first component.

At 1308, an adhesive is applied in the channel, such that the additively-manufactured component, the sensor, and the second component are joined, and the connection point is accessible external to the adhesive.

The previous description is provided to enable any person ordinarily skilled in the art to practice the various aspects described herein. Various modifications to these exemplary embodiments presented throughout this disclosure will be readily apparent to those of ordinary skill in the art, and the concepts disclosed herein may be applied to aluminum alloys. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus, comprising:
an additively-manufactured component comprising a channel;
a sensor including an connection point, wherein the sensor is arranged in the channel; and
an adhesive arranged in the channel, the adhesive coupling the additively-manufactured component to the sensor, such that the connection point is accessible external to the adhesive, the sensor being configured to provide a signal at the connection point, wherein the signal provides information of an applied force on the additively-manufactured component.

2. The apparatus of claim 1, further comprising a second component, wherein the adhesive further couples the second component to the additively-manufactured component.

3. The apparatus of claim 1, wherein the at least one sensor is placed in the channel after the additively-manufactured component is formed.

4. The apparatus of claim 1, wherein a shape of the channel in the additively-manufactured component is configured to transmit the applied force to the sensor.

5. The apparatus of claim 1, wherein the sensor is manufactured as part of the additively-manufactured component.

6. The apparatus of claim 5, wherein the sensor is additively-manufactured.

7. The apparatus of claim 6, wherein the sensor comprises a first material, and the additively-manufactured component comprises a second material different that the first material.

8. The apparatus of claim 1, wherein sensor comprises a Wheatstone bridge.

9. An apparatus, comprising:
an additively-manufactured component including a structure, the structure being configured to produce an indicator, the indicator corresponding to a force applied to the additively-manufactured component.

10. The apparatus of claim 9, wherein the structure includes a lattice structure.

11. The apparatus of claim 9, wherein the indicator further indicates a direction of the force applied to the additively-manufactured component.

12. The apparatus of claim 9, further comprising an adhesive coupled to the additively-manufactured component.

13. The apparatus of claim 12, wherein the adhesive includes a piezo-resistive adhesive.

14. The apparatus of claim 13, wherein the additively-manufactured component includes a junction for another component.

15. A method comprising:
additively-manufacturing a first component including a channel;
arranging a sensor in the channel, the sensor including a connection point;
arranging a second component proximate to the first component; and
applying an adhesive in the channel, such that the additively-manufactured component, the sensor, and the second component are joined, and the connection point is accessible external to the adhesive.

16. The method of claim 15, further comprising:
measuring a signal applied to the sensor, wherein the signal provides information of an applied force on the additively-manufactured component.

17. The method of claim 15, wherein the information indicates a force applied to the channel.

18. The method of claim 15, wherein the second component is an additively-manufactured component.

19. The method of claim 15, wherein the sensor includes a strain gauge.
